(19) United States
(12) Patent Application Publication
(10) Pub. No.: US 2021/0146450 A1
(43) Pub. Date: May 20, 2021

(54) THREAD MILLING TOOL

(71) Applicant: Hartmetall-Werkzeugfabrik Paul Horn GmbH, Tuebingen (DE)

(72) Inventors: Peter Paul Schmida, Muenster (AT); Manfred Josef Schwaiger, Radstadt (AT)

(21) Appl. No.: 17/162,520

(22) Filed: Jan. 29, 2021

Related U.S. Application Data
(63) Continuation of application No. PCT/EP2019/068643, filed on Jul. 11, 2019.

(30) Foreign Application Priority Data
Aug. 16, 2018 (DE) 10 2018 119 928.7

(51) Int. Cl. B23B 27/06

(52) U.S. Cl. CPC B23B 27/065; B23B 27/16

(57) ABSTRACT

A thread milling tool for producing a thread. The thread milling tool comprises a tool holder, which extends along a central axis and comprises a first slot-shaped cutting insert receptacle having two opposing lateral abutment surfaces and a base abutment surface arranged between the two lateral abutment surfaces and extending transversely thereto, the abutment surface forming a base of the first slot-shaped cutting insert receptacle. The thread milling tool further comprises a first cutting insert, which is fixed in the first cutting insert receptacle in a firmly bonded manner, wherein the first cutting insert comprises a base body having two opposing lateral surfaces, which abut against the two lateral abutment surfaces of the first cutting insert receptacle or are connected in a firmly bonded manner thereto, and having a lower side arranged between the two lateral surfaces and extending transversely thereto, wherein the lower surface abuts against or is connected in a firmly bonded manner to the base abutment surface of the first cutting insert receptacle, and wherein the first cutting insert comprises at least one cutting tooth that projects outwardly from the base body beyond the first cutting insert receptacle and comprises two main cutting edges for producing two opposing flanks of the thread.

### CROSS REFERENCE TO RELATED APPLICATIONS

This application is a continuation of international patent application PCT/EP2019/068643, filed on Jul. 11, 2019 designating the U.S., which international patent application has been published in German language and claims priority from German patent application DE 10 2018 119 928.7, filed on Aug. 16, 2018. The entire contents of these priority applications are incorporated herein by reference.

### BACKGROUND

This disclosure relates to a thread milling tool for producing a thread, preferably an internal thread, on a workpiece.

The presented thread milling tool is particularly suitable for machining workpieces made of sintered cemented carbide or ceramics. However, the use of the presented thread milling tool is not limited to the machining of workpieces made of such materials, nevertheless, this is the preferred application.

Sintered cemented carbide has a very high hardness. In addition to its use as a cutting material, sintered cemented carbide is also frequently used in forming technology as a punch, hammer or as a wear part.

The production of threads on or in such components made of sintered cemented carbide has so far mostly been carried out with solid cemented carbide thread milling tools whose cutting edges are coated with a diamond layer. However, the service life of such solid cemented carbide thread milling tools with diamond-coated cutting edges is very short, so that the use of such thread milling tools has proven to be cost-intensive. In addition, the cutting edges must be ground very precisely, which makes their manufacture complex and thus also cost-intensive. Due to the machining of the cutting edges by means of grinding, the cutting edges must also be relatively large, or at least the receptacle for the cutting edges on the tool holder must be relatively large in order to make the cutting edges accessible for the grinding tool. Accordingly, only relatively few cutting edges or cutting inserts can be attached to smaller tool holders.

### SUMMARY

It is an object to provide a thread milling tool that overcomes the above-mentioned problems and is particularly suitable for machining sintered cemented carbide or ceramics.

According to a first aspect, a thread milling tool is presented, comprising:
a tool holder, which extends along a central axis and comprises a first slot-shaped cutting insert receptacle having two opposing lateral abutment surfaces and a base abutment surface arranged between the two lateral abutment surfaces and extending transversely thereto, the abutment surface forming a base of the first slot-shaped cutting insert receptacle;
a first cutting insert, which is fixed in the first cutting insert receptacle in a firmly bonded manner, wherein the first cutting insert comprises a base body having two opposing lateral surfaces, which abut against the two lateral abutment surfaces of the first cutting insert receptacle or are connected in a firmly bonded manner thereto, and having a lower side arranged between the two lateral surfaces and extending transversely thereto, wherein the lower surface abuts against or is connected in a firmly bonded manner to the base abutment surface of the first cutting insert receptacle, and wherein the first cutting insert comprises at least one cutting tooth that projects outwardly from the base body beyond the first cutting insert receptacle and comprises two main cutting edges that are configured to produce two opposing flanks of the thread,
wherein a distance between the two lateral abutment surfaces of the first cutting insert receptacle is greater than a distance between the two lateral of the first cutting insert.

According to a second aspect, a thread milling tool is presented, comprising:
a tool holder, which extends along a central axis and comprises a first slot-shaped cutting insert receptacle having two opposing lateral abutment surfaces and a base abutment surface arranged between the two lateral abutment surfaces and extending transversely thereto, the abutment surface forming a base of the first slot-shaped cutting insert receptacle;
a first cutting insert, which is fixed in the first cutting insert receptacle in a firmly bonded manner, wherein the first cutting insert comprises a base body having two opposing lateral surfaces, which are soldered to the two lateral abutment surfaces of the first cutting insert receptacle, and having a lower side arranged between the two lateral surfaces and extending transversely thereto, wherein the lower surface is soldered to the base abutment surface of the first cutting insert receptacle, and wherein the first cutting insert comprises at least one cutting tooth that projects outwardly from the base body beyond the first cutting insert receptacle and comprises two main cutting edges that are configured to produce two opposing flanks of the thread.

According to a third aspect, a thread milling tool is presented, comprising:
a tool holder, which extends along a central axis and comprises a first slot-shaped cutting insert receptacle having two opposing lateral abutment surfaces and a base abutment surface arranged between the two lateral abutment surfaces and extending transversely thereto, the abutment surface forming a base of the first slot-shaped cutting insert receptacle;
a first cutting insert, which is fixed in the first cutting insert receptacle in a firmly bonded manner, wherein the first cutting insert comprises a base body having two opposing lateral surfaces, which abut against the two lateral abutment surfaces of the first cutting insert receptacle or are connected in a firmly bonded manner thereto, and having a lower side arranged between the two lateral surfaces and extending transversely thereto, wherein the lower surface abuts against or is connected in a firmly bonded manner to the base abutment surface of the first cutting insert receptacle, and wherein the first cutting insert comprises at least one cutting tooth that projects outwardly from the base body beyond the first cutting insert receptacle and comprises two main cutting edges that are configured to produce two opposing flanks of the thread, wherein the first cutting insert projects beyond a front end of the tool holder.

According to a refinement, the tool holder is made of cemented carbide and the first cutting insert is made of CVD thick-film diamond. The configuration of the tool holder made of cemented carbide allows for an extremely stable basic structure of the thread milling tool. The configuration of the first cutting insert made of CVD thick-film diamond enables the production of extremely precise cutting edges that have excellent frictional properties and a high hardness. The firmly bonded connection of the first cutting insert in a slot-shaped or groove-shaped insert receptacle (referred to herein as the “first cutting insert receptacle”) creates an extremely stable connection between the first cutting insert and the tool holder, which enables very high torques to be transmitted.

The slot-shaped or groove-shaped configuration of the first cutting insert receptacle also enables an extremely space-saving attachment of the first cutting insert to the tool holder. The thread milling tool can thus in principle be configured with a plurality of such cutting inserts, wherein generally one cutting insert, which is referred to herein as the first cutting insert, is sufficient for the function of the thread milling tool.

The above-mentioned features thus make it possible to realize an extremely stable and high-precision thread milling tool which, compared thread milling tools known from the prior art, enables long service lives and can thus be manufactured comparatively inexpensively despite the somewhat higher costs for the cutting insert if it is made of CVD thick-film diamond. Due to the immense stability of the first cutting insert, of the tool holder as well as of their connection, it is possible with the thread milling tool to machine highhardness materials efficiently and with low stress.

The machining of the workpiece, i.e. the cutting of the thread, is carried out by means of the at least one cutting tooth, which projects outwards from the base body of the first cutting insert. The base body of the first cutting insert is used for mounting (firmly bonded connection) of the first cutting insert on the tool holder or in the first cutting insert receptacle.

The at least one cutting tooth preferably comprises two identical main cutting edges. The shape of the main cutting edges and their alignment to each other are adapted to the desired thread shape of the thread to be produced with the thread milling tool. The main cutting edges each cut the thread flanks. In principle, the shape of the at least one cutting tooth or the main cutting edges can be adapted to any thread shape. In the case of the production of a metric or pointed thread, the two main cutting edges of the at least one cutting tooth are oriented at an acute angle to one another and are preferably connected to one another via a radius that forms the tip of the cutting tooth.

According to a refinement, the first cutting insert comprises at least two cutting teeth projecting outwardly from the base body beyond the first cutting insert receptacle, each of the at least two cutting teeth having two main cutting edges, preferably of identical length and oriented at an acute angle with respect to each other.

According to another refinement, the two opposing lateral surfaces of the first cutting insert are soldered to the two lateral abutment surfaces of the first cutting insert receptacle. Thus, a first of the two lateral surfaces is soldered to a first of the two lateral abutment surfaces and a second of the two lateral surfaces is soldered to a second of the two lateral abutment surfaces. Similarly, the lower surface of the first cutting insert is soldered to the base abutment surface of the first cutting insert receptacle.

The first cutting insert is thus soldered to the tool holder according to this refinement on three of its sides. This creates an extremely stable and sustainable connection between the first cutting insert and the first cutting insert receptacle, which enables the transmission of high torques. Soldering the first cutting insert in the first cutting insert receptacle also has the advantage that the interface between the cutting insert and cutting insert receptacle is subjected to a relatively uniform load during machining of a workpiece. On the other hand, a point load, as would occur if the first cutting insert were fastened by means of a screw, could lead to fracture of the cutting insert, since the CVD thick-film diamond from which the first cutting insert is made has a high hardness, but at the same time is relatively brittle. Such a threat of fracture of the first cutting insert can be effectively avoided by soldering the first cutting insert on three sides.

Alternatively, the first cutting insert could also be welded to the first cutting insert receptacle. However, soldering the first cutting insert to the tool holder is simpler and therefore more cost-effective.

According to a refinement, the two lateral abutment surfaces of the first cutting insert receptacle are preferably oriented parallel to each other.

On the one hand, this enables relatively simple insertion of the first cutting insert into the first cutting insert receptacle and thus simple fastening of the first cutting insert in the first cutting insert receptacle. On the other hand, this optimizes the force transmission between the tool holder and the first cutting insert.

According to a further refinement, a distance between the two lateral abutment surfaces of the first cutting insert receptacle is greater than a distance between the two lateral surfaces of the first cutting insert.

In other words, the first cutting insert receptacle is wider than the first cutting insert. This simplifies the mounting of the first cutting insert on the tool holder and also makes it possible, in the case of soldering the insert to the tool holder, to bring the solder (soldering material) into the space between the first cutting insert and the first cutting insert receptacle during the manufacture of the thread milling tool. Thus, the first cutting insert is preferably not pressed into the first cutting insert receptacle, but merely inserted therein and subsequently soldered. This reduces the internal stresses within the tool holder and the cutting insert.

According to another refinement, the two lateral abutment surfaces of the first cutting insert receptacle are oriented parallel to a radial direction or at an angle <5° to the radial direction, wherein the radial direction is orthogonal to the central axis of the tool holder.

It is particularly preferred to orient the two lateral abutment surfaces transversely (i.e. not parallel) at an angle <5° is, as this produces a rake angle

According to a further refinement, the two lateral abutment surfaces of the first cutting insert receptacle are oriented parallel to the central axis of the tool holder. In particular in a refinement with two cutting teeth or more, the cutting teeth thus preferably come into engagement with the workpiece simultaneously.

According to a further refinement, the first cutting insert projects beyond a front end of the tool holder. Preferably, a planar surface is arranged on the front end of the cutting insert, which planar surface projects beyond the front end of the tool holder and is oriented orthogonally to the central axis of the tool holder. This can be used for axial support of the thread milling tool.

As already mentioned, the thread milling tool can also be equipped with more than one cutting insert, for example with two, three, four, five or six cutting inserts. The cutting inserts then preferably all have the same shape and size. They are arranged in corresponding cutting insert receptacles, which are similar to the first cutting insert receptacle described above, i.e. are also designed as slot-shaped or groove-shaped cutting insert receptacles. In the case of several cutting inserts or several cutting insert receptacles, the cutting inserts or cutting insert receptacles, respectively, are preferably evenly distributed around the circumference of the tool holder.

It is understood that the above-mentioned features and those yet to be explained can be used not only in the combination indicated in each case, but also in other combinations or on their own, without departing from the spirit and scope of the present disclosure.

### BRIEF DESCRIPTION OF THE DRAWINGS

FIG. 1 shows a perspective view of a thread milling tool according to an embodiment;

FIG. 2 shows a detail of a machining head of the thread milling tool from FIG. 1 in a perspective view;

FIG. 3 shows the machining head from FIG. 2 in a side view;

FIG. 4 shows the machining head from FIG. 2 in a top view from the front;

FIG. 5 shows the machining head from FIG. 2 in a top view from the front without cutting inserts inserted therein; and

FIG. 6 shows the machining head from FIG. 2 in a perspective view without cutting inserts inserted therein.

### DESCRIPTION OF PREFERRED EMBODIMENTS

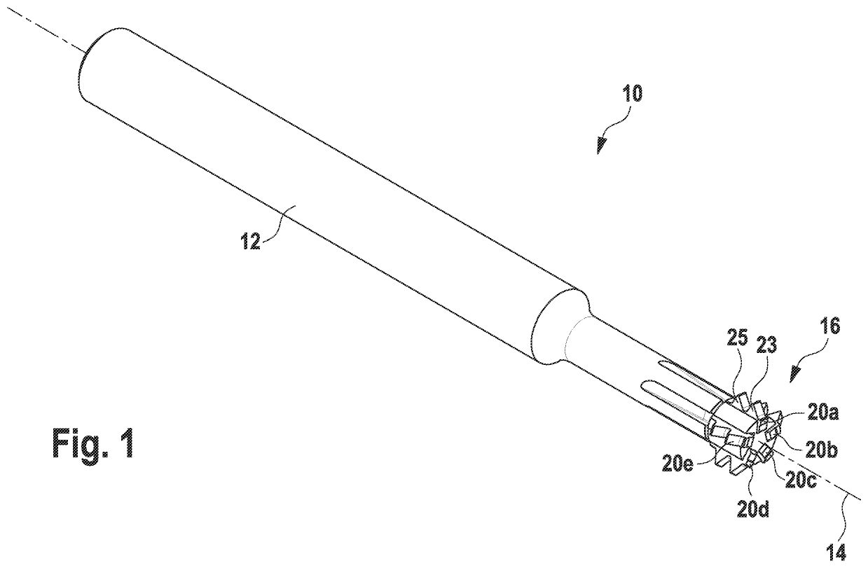

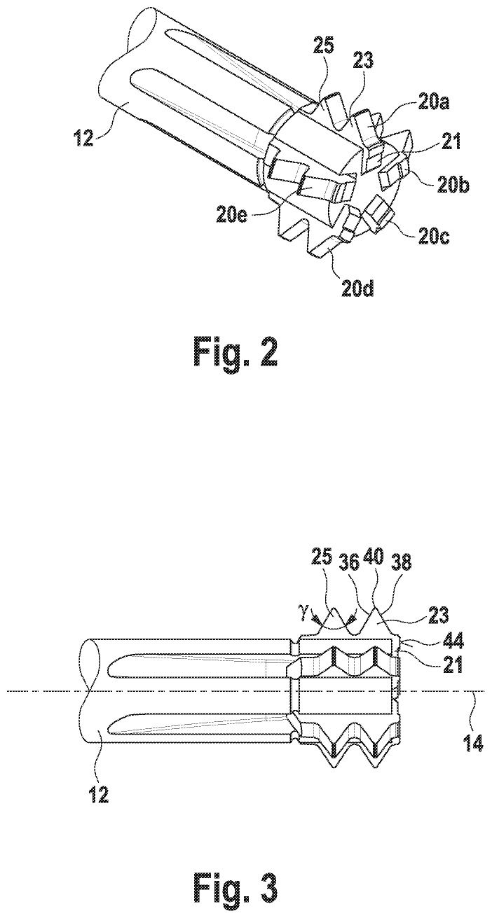

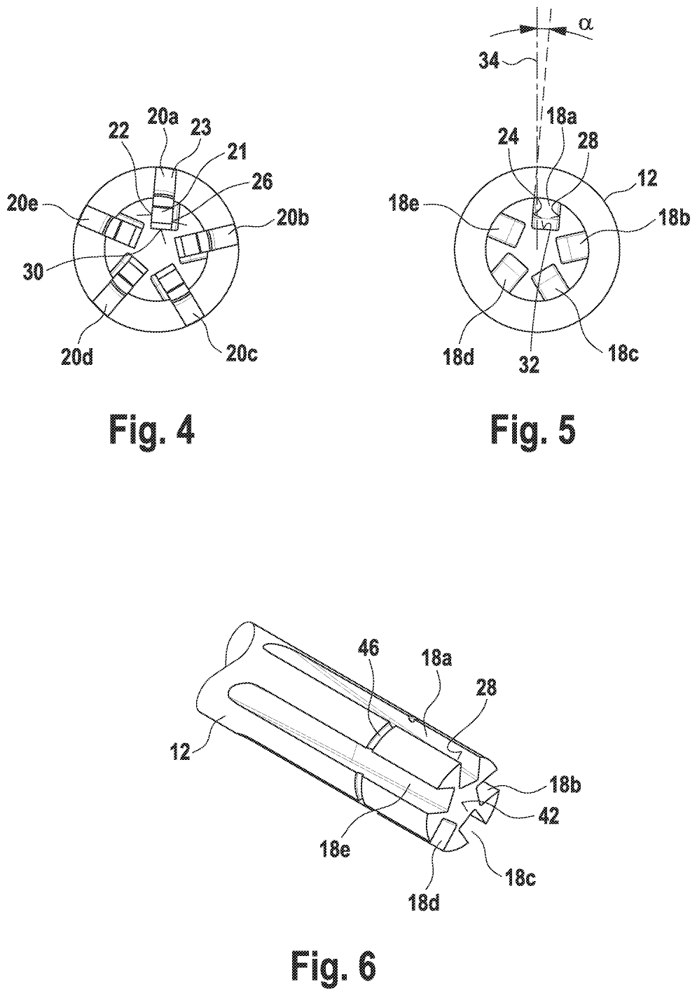

FIG. 1 shows a perspective view of an embodiment of the thread milling tool. The thread milling tool is denoted therein in its entirety with the reference numeral 10.

The thread milling tool 10 comprises a tool holder 12 which extends along a central axis 14. The thread milling tool 10 is preferably, but not necessarily, rotationally symmetrical with respect to the central axis 14. In the area of its front end, the thread milling tool 10 comprises a machining head 16 with which a workpiece to be machined is machined. This machining head 16 is used for milling a thread on or in a workpiece to be machined.

In the herein shown embodiment, the tool holder 12 comprises five cutting insert receptacles 18a-18e in the area of the machining head 16, which cutting insert receptacles are referred to as the first, second, third, fourth and fifth cutting insert receptacles 18a-18e, respectively, for better differentiation (see FIG. 5). The cutting insert receptacles 18a-18e each serve to receive a cutting insert 20a-20e, which are referred to herein as the first, second, third, fourth and fifth cutting insert 20a-20e, respectively.

The cutting insert receptacles 18a-18e and the cutting inserts 20a-20e are preferably evenly distributed around the circumference of the tool holder 12 and around the circumference of the thread milling tool 10, respectively. The tool holder 12 is preferably made of cemented carbide. The cutting inserts 20a-20e are preferably made of CVD thick film diamond.

Although the thread milling tool 10 in the embodiment shown is provided with five cutting inserts 20a-20e in the herein shown embodiment, it should be noted at this point that only one cutting insert, for example the first cutting insert 20a, would also be sufficient for the function of the thread milling tool 10. Just as well, the thread milling tool could also be provided with two, three, four or more than five cutting inserts without leaving the scope of the present disclosure.

The use of multiple cutting inserts increases the stability as well as the service life of the thread milling tool 10. However, since the use of only one cutting insert is sufficient for the function of the thread milling tool 10, the method of mounting the cutting inserts 20a-20e within the cutting insert receptacles 18a-18e will be explained in detail below for the sake of simplicity only with reference to the first cutting insert 20a and the first cutting insert receptacle 18a, respectively. When several cutting inserts or cutting insert receptacles are used, the remaining cutting inserts 20b-20e and the remaining cutting insert receptacles 18b-18e, respectively, are preferably configured in the same or equivalent shape.

The first cutting insert receptacle 18a is configured as a slot-shaped or groove-shaped receptacle pocket, which is formed into the tool holder 12 in the area of the machining head 16 and is accessible from outside both in the axial direction, i.e. parallel to the central axis 14, and circumferentially. The first cutting insert 20a is inserted into the first cutting insert receptacle 18a in such a way that it projects both in the axial direction beyond the front end of the tool holder 12 and circumferentially beyond the circumference of the tool holder 12.

The first cutting insert 20a (as well as the other cutting inserts 20b-20e) comprises a base body 21, which is inserted into and fixed in the first cutting insert receptacle 18a. At least one cutting tooth 23 projects from the base body and projects from the cutting insert receptacle 18a. The at least one cutting tooth 23 is integrally connected to the base body 21. The at least one cutting tooth 23 is used for machining or producing the thread flanks of the thread to be produced. In the herein shown embodiment, the first cutting insert 20a comprises two cutting teeth 23, 25 which are preferably identical in shape and size. It should be noted, however, that in principle only one of these cutting teeth is sufficient to produce a thread. Likewise, more than two cutting teeth could also be attached to the first cutting insert 20a.

The base body 21 of the first cutting insert 20a is not only inserted into the first cutting insert receptacle 18a, but is also connected thereto in a firmly bonded manner. Preferably, the base body 21 of the first cutting insert 20a is soldered to the tool holder 12 in the first cutting insert receptacle 18a. Particularly preferably, the cutting insert 20a is soldered to the cutting insert receptacle 18a on three of its sides. A first lateral surface 22 of the first cutting insert 20a is soldered to a first lateral abutment surface 24 of the first cutting insert receptacle 18a. An opposite second lateral surface 26 of the first cutting insert 20a is soldered to a second lateral abutment surface 28 of the first cutting insert receptacle 18a. A lower surface 30 of the first cutting insert 20a is soldered to a base abutment surface 32 of the first cutting insert receptacle 18a.

Although it is preferred that the first cutting insert 20a is soldered to the first cutting insert receptacle 18a at all three of mentioned surfaces 22, 26, 30, it would be generally conceivable to solder the first cutting insert 20a to the first cutting insert receptacle 18a at only one or two of these surfaces 22, 26, 30. Soldering the first cutting insert 20a at all three named surfaces 22, 26, 30, however, increases the stability of the connection between the first cutting insert 20a and the tool holder 12.

The two opposing lateral abutment surfaces 24, 28 form the flanks of the groove- or slot-shaped first cutting insert receptacle 18a. They preferably run parallel to each other. The base abutment surface 32 extending between the two lateral abutment surfaces 24, 28 forms the base or groove base of the groove- or slot-shaped first cutting insert receptacle 18a. This base abutment surface 32 extends transversely (i.e., not parallel) to the two lateral abutment surfaces 24, 28. Preferably, the base abutment surface 32 is oriented orthogonally to the two lateral abutment surfaces 24, 28.

A similar condition applies to the lateral surfaces 22, 26 and the lower surface 30 of the first cutting insert 20a. The two lateral surfaces 22, 26 preferably extend parallel to each other and transversely (i.e., not parallel) to the lower surface 30. Preferably, the lower surface 30 is oriented orthogonally to the two lateral surfaces 22, 26.

In order to facilitate the insertion of the first cutting insert 20a into the first cutting insert receptacle 18a and in order to be able to introduce solder at said locations between the cutting insert 20a and the lateral flanks 24, 28 of the first cutting insert receptacle 18a, the first cutting insert receptacle 18a is preferably wider than the first cutting insert 20a. Thus, a distance that the two lateral abutment surfaces 24, 28 have from each other is preferably greater than a distance that the two lateral surfaces 22, 26 have from each other.

Although the first cutting insert 20a can generally be inserted exactly radially into the tool holder 12, the first cutting insert receptacle 18a and thus also the first cutting insert 20a are somewhat inclined with respect to the radial direction of the tool holder 12 in the herein shown embodiment. The first lateral abutment surface 24 as well as the second lateral abutment surface 28 each include an angle α with the radial direction, which is shown as dashed in FIG. 5 and is provided with the reference numeral 34, which angle is preferably in the range of 0°-5°. The corresponding inclination of the first cutting insert 20a results in a rake angle at the main cutting edge 36 of the first cutting insert 20a.

In contrast, with respect to the central axis 14 of the tool holder 12, the two lateral abutment surfaces 24, 28 of the first cutting insert receptacle 18a are not inclined, but preferably run parallel to the central axis 14, as can be seen, for example, in the view in FIG. 3.

The two cutting teeth 23, 25 of the first cutting insert 20a each comprise two main cutting edges 36, 38, by means of which the thread flanks are produced. The main cutting edges 38, 38 are preferably configured as straight, linear cutting edges, but can also have a correspondingly adapted shape depending on the shape of the thread to be produced. The herein shown embodiment of the thread milling tool 10 serves to produce a metric thread or a pointed thread. The two main cutting edges 36, 38 in this embodiment are therefore oriented at an acute angle γ to each other (see FIG. 3). At the tip of the cutting teeth 23, 25, the main cutting edges 36, 38 are each connected to each other via a radius 40.

The first cutting insert 20a as well as the other cutting inserts 20b-20e project not only radially but preferably also axially, i.e. parallel to the central axis 14, beyond the tool holder 12. At the front end, the tool holder 12 has an end face 42 that is preferably oriented orthogonally to the central axis 14 (see FIG. 6). At the front end of the tool holder 12, the cutting insert receptacles 18a-18e open into this end face termination surface 42. At their front ends, the cutting inserts 20a-20e each have a front surface 44 which projects axially beyond the end face termination surface 42 of the tool holder 12 and is also preferably oriented orthogonally to the central axis 14 (see FIG. 3). These front surfaces 44 can be used to align the cutting inserts 20a-20e relative to each other during assembly of the thread milling tool 10.

In FIGS. 3 and 6, a groove 54 extending in the circumferential direction can also be seen. This groove 54 is used to attach a positioning device, for example a positioning ring, by means of which the cutting inserts 20a-20e can be aligned with respect to each other in the axial direction during attachment to the tool holder 12. The positioning device (not shown here) can subsequently be removed again as soon as the cutting inserts 20a-20e are fixed in the cutting insert receptacles 18a-18e.

It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

What is claimed is:

1. A thread milling tool comprising:
a tool holder, which extends along a central axis and comprises a first slot-shaped cutting insert receptacle having two opposing lateral abutment surfaces and a base abutment surface arranged between the two lateral abutment surfaces and extending transversely thereto, the abutment surface forming a base of the first slot-shaped cutting insert receptacle;
a first cutting insert, which is fixed in the first cutting insert receptacle in a firmly bonded manner, wherein the first cutting insert comprises a base body having two opposing lateral surfaces, which abut against the two lateral abutment surfaces of the first cutting insert receptacle or are connected in a firmly bonded manner thereto, and having a lower side arranged between the two lateral surfaces and extending transversely thereto, wherein the lower surface abuts against or is connected in a firmly bonded manner to the base abutment surface of the first cutting insert receptacle, and wherein the first cutting insert comprises at least one cutting tooth that projects outwardly from the base body beyond the first cutting insert receptacle and comprises two main cutting edges that are configured to produce two opposing flanks of the thread,
wherein a distance between the two lateral abutment surfaces of the first cutting insert receptacle is greater than a distance between the two lateral of the first cutting insert.

2. The thread milling tool according to claim 1, wherein the two main cutting edges are identical.

3. The thread milling tool according to claim 1, wherein the two main cutting edges are oriented at an acute angle to each other.

4. The thread milling tool according to claim 1, wherein the two main cutting edges are connected to each other via a radius.

5. The thread milling tool according to claim 1, wherein the two opposing lateral surfaces of the first cutting insert are soldered to the two lateral abutment surfaces of the first cutting insert receptacle, and wherein the lower surface of the first cutting insert is soldered to the base abutment surface of the first cutting insert receptacle.

6. The thread milling tool according to claim 1, wherein the two lateral abutment surfaces are oriented parallel to each other.

7. The thread milling tool according to claim 1, wherein the two lateral abutment surfaces of the first cutting insert receptacle are oriented parallel to a radial direction or at an angle smaller than 5° to the radial direction, wherein the radial direction is orthogonal to the central axis of the tool holder.

8. The thread milling tool according to claim 1, wherein the two lateral abutment surfaces of the first cutting insert receptacle are oriented parallel to the central axis of the tool holder.

9. The thread milling tool according to claim 1, wherein the first cutting insert projects beyond a front end of the tool holder.

10. The thread milling tool according to claim 1, wherein the tool holder comprises a plurality of slot-shaped cutting insert receptacles that have a same shape and size as the first cutting insert receptacles and that are arranged distributed around a circumference of the tool holder, and wherein the thread milling tool comprises a plurality of cutting inserts that have a same shape and size as the first cutting insert and that are fixed in a respective one of the slot-shaped cutting insert receptacles in a same manner as the first cutting insert is fixed in the first cutting insert receptacle.

11. The thread milling tool according to claim 1, wherein the tool holder is made of cemented carbide, and wherein the plurality of cutting inserts are made of CVD thick-film diamond.

12. A thread milling tool comprising:
a tool holder, which extends along a central axis and comprises a first slot-shaped cutting insert receptacle having two opposing lateral abutment surfaces and a base abutment surface arranged between the two lateral abutment surfaces and extending transversely thereto, the abutment surface forming a base of the first slot-shaped cutting insert receptacle;
a first cutting insert, which is fixed in the first cutting insert receptacle in a firmly bonded manner, wherein the first cutting insert comprises a base body having two opposing lateral surfaces, which are soldered to the two lateral abutment surfaces of the first cutting insert receptacle, and having a lower side arranged between the two lateral surfaces and extending transversely thereto, wherein the lower surface is soldered to the base abutment surface of the first cutting insert receptacle, and wherein the first cutting insert comprises at least one cutting tooth that projects outwardly from the base body beyond the first cutting insert receptacle and comprises two main cutting edges that are configured to produce two opposing flanks of the thread.

13. The thread milling tool according to claim 12, wherein the tool holder is made of cemented carbide, and wherein the plurality of cutting inserts are made of CVD thick-film diamond.

14. The thread milling tool according to claim 12, wherein a distance between the two lateral abutment surfaces of the first cutting insert receptacle is greater than a distance between the two lateral of the first cutting insert.

15. The thread milling tool according to claim 12, wherein the two main cutting edges are oriented at an acute angle to each other.

16. The thread milling tool according to claim 12, wherein the two main cutting edges are connected to each other via a radius.

17. A thread milling tool comprising:
a tool holder, which extends along a central axis and comprises a first slot-shaped cutting insert receptacle having two opposing lateral abutment surfaces and a base abutment surface arranged between the two lateral abutment surfaces and extending transversely thereto, the abutment surface forming a base of the first slot-shaped cutting insert receptacle;
a first cutting insert, which is fixed in the first cutting insert receptacle in a firmly bonded manner, wherein the first cutting insert comprises a base body having two opposing lateral surfaces, which abut against the two lateral abutment surfaces of the first cutting insert receptacle or are connected in a firmly bonded manner thereto, and having a lower side arranged between the two lateral surfaces and extending transversely thereto, wherein the lower surface abuts against or is connected in a firmly bonded manner to the base abutment surface of the first cutting insert receptacle, and wherein the first cutting insert comprises at least one cutting tooth that projects outwardly from the base body beyond the first cutting insert receptacle and comprises two main cutting edges that are configured to produce two opposing flanks of the thread,
wherein the first cutting insert projects beyond a front end of the tool holder.

18. The thread milling tool according to claim 17, wherein the tool holder is made of cemented carbide, and wherein the plurality of cutting inserts are made of CVD thick-film diamond.

19. The thread milling tool according to claim 17, wherein the two opposing lateral surfaces of the first cutting insert are soldered to the two lateral abutment surfaces of the first cutting insert receptacle, and wherein the lower surface of the first cutting insert is soldered to the base abutment surface of the first cutting insert receptacle.

20. The thread milling tool according to claim 17, wherein the two lateral abutment surfaces are oriented parallel to each other.
